(19) United States
(12) Patent Application Publication
(10) Pub. No.: US 2026/0319620 A1
(43) Pub. Date: Oct. 15, 2026

(54) TOUCHSCREEN DEVICE AND METHOD FOR PROCESSING TOUCH SENSOR DATA

(71) Applicant: Huawei Technologies Co., Ltd., Shenzhen (CN)

(72) Inventors: Manpreet Singh Takkar, Brampton (CA); Wei Zhou, Richmond Hill (CA); Yen-Ting Yeh, Kanata (CA)

(21) Appl. No.: 19/177,235

(22) Filed: Apr. 11, 2025

(51) Int. Cl. G06F 3/041; G06V 10/25; G06V 10/426; G06V 10/62; G06V 10/764; G06V 40/10

(52) U.S. Cl. CPC G06F 3/04186; G06V 10/25; G06V 10/426; G06V 10/62; G06V 10/764; G06V 40/11

(57) ABSTRACT

The discloses provides a method for resolving the issue of accurately segmenting and determining the Region of Interest when two or more touches are in close proximity is provided, thereby improving touch detection and reducing errors and a method for reliably distinguishing between intentional finger touches and palm touches based on capacitive sensor data are provided, also enabling the system to effectively differentiate between deliberate user input and accidental palm contact. A method, a touchscreen device and a device driver are disclosed. A touch image comprising a plurality of active pixels is obtained from a touch sensor. One or more touch blobs are extracted from the touch image to create blob images. For each blob image, a query, keys and values are generated by an encoder using the output of a region-of-interest predictor, which makes it possible to use cross-attention to predict the probability of the touch being intentional or not.

### TECHNICAL FIELD

The technical field relates to digital data input processing, and more specifically to touchscreen devices and methods for processing touch sensor data.

### BACKGROUND

The increasing ubiquity of virtual keyboards on large tablets and dual-screen devices underscores the need for a sophisticated palm rejection mechanism. As users interact with these devices, their palms often inadvertently make contact with the screen, resulting in unwanted keystrokes and decreased typing accuracy. Currently, some devices employ basic palm rejection techniques, such as those utilized on curved screen displays, which rely on location and time-based algorithms to distinguish between intentional finger touches and palm contact. For instance, if a touch is detected in the edge region of the screen for an extended period, it is deemed noise and the capacitive base is adjusted accordingly. However, most commercial palm rejection systems rely on rudimentary methods that solely consider the dead zone and the width and height of touch inputs. While these approaches provide some level of palm rejection, they are inherently limited in their potential and flexibility, restricting the range of allowed interactions and hindering the overall user experience.

Existing palm rejection techniques rely on simplistic threshold-based methods for touch detection, where the Region of Interest (RoI) for each touch is determined by values exceeding or falling below a predetermined threshold. However, this approach often falters when dealing with multiple fingers in close proximity, leading to decreased accuracy.

Furthermore, palm detection and classification methods typically employ basic features, such as the width and height of the touch blob, which can be insufficient for robust palm rejection. Additionally, some methods utilize region-based approaches, which classify touches as palm or non-palm based on their location on the screen, such as designating a “dead zone” or relying on the hand to be positioned at the edge of the screen. These simplistic approaches can be limited in their effectiveness, highlighting the need for more advanced and nuanced palm rejection solutions.

The existing method of segmenting touches and determining the RoI based on a single threshold value is inherently flawed. Specifically, selecting a threshold value that is too low can lead to the erroneous segmentation of multiple nearby touches as a single touch, resulting in inaccurate touch detection. Conversely, choosing a threshold value that is too high can cause the loss of critical information at the edge of the touch region, as it may be excluded from the RoI.

Furthermore, relying solely on basic features such as width, height, or location of the touch region for palm detection can compromise the robustness and accuracy of the system, leading to false positives or false negatives and ultimately hindering the overall performance of the palm rejection mechanism.

### SUMMARY

The present disclosure addresses two primary challenges inherent in existing palm rejection systems. Firstly, a method for resolving the issue of accurately segmenting and determining the Region of Interest (RoI) when two or more touches are in close proximity is provided, thereby improving touch detection and reducing errors. Secondly, methods for reliably distinguishing between intentional finger touches and intentional or unintentional, i.e., accidental, palm touches based on capacitive sensor data are provided, also enabling the system to effectively differentiate between deliberate user input, also called “intentional finger touch”, and intentional or accidental palm contact, also called “intentional or accidental palm touch” or more simply “palm contact” or “palm touch”. The decision for each touch takes into consideration a context from other touches. By addressing these challenges, the present disclosure can enable seamless palm-on-screen typing behaviour, while also mitigating the impact of accidental palm touches that may occur during activities such as typing, drawing, or other interactive tasks.

In accordance with an aspect, a method for processing touch sensor data based on a first and second thresholds is provided. The method implements a region-of-interest predictor. The method comprises obtaining a touch image from the touch sensor, the touch image comprising a plurality of active pixels, each of the active pixels indicating a sensor response, generating a graph comprising a set of vertices and a set of edges, each of the vertices being associated with an active pixel and being decorated, e.g., labelled, with the sensor response of the active pixel, and each of the edges being associated with a pair of adjacent pixels of the active pixels and connecting a pair of vertices associated with the pair of adjacent pixels, traversing the graph to identify one or more subgraphs connected through connecting vertices each decorated with a sensor response above the first threshold, continuing traversing the graph to expend the subgraphs until a cutoff condition related to a current vertex and a previous vertex is met, and generating one or more touch blobs, each corresponding to one of the subgraphs. The cutoff conditions comprise the current vertex being decorated with a sensor response greater than the sensor response decorating the previous vertex, the current vertex being already part of one of the components, and the current vertex being decorated with a sensor response less than the second threshold, wherein the second threshold is less than the first threshold.

In accordance with another aspect, a touchscreen device implementing the method above is provided.

In accordance with a further aspect, a device driver implementing the method above is provided.

In accordance with yet another aspect, a method for processing touch sensor data is provided. The method comprises obtaining a touch image from the touch sensor, the touch image comprising a plurality of active pixels, each of the active pixels indicating a sensor response, extracting one or more touch blobs from the touch image and corresponding one or more region-of-interests by a region-of-interest predictor, obtaining a plurality of blob images, each associated with one respective touch blob of the touch blobs, generating, for each respective blob image of the blob images, at least one respective query, respective keys and respective values by encoding the respective blob image using a feature extractor, and for each respective blob image of the blob images, predicting whether the respective associated touch blob corresponds to an intentional finger touch or to a palm touch based on spatial context. The prediction comprises generating a context vector for the respective blob image based on cross-attention between the respective blob image and the plurality of blob images, generating a predicted probability that the blob image corresponds to an intentional finger touch and a predicted probability that the blob image corresponds to a palm touch by inputting the context vector in a classifier, and predicting that the respective touch image corresponds to an intentional finger touch if the predicted probability that the touch image corresponds to an intentional finger touch is greater than the predicted probability that the touch image corresponds to a palm touch.

In accordance with yet a further aspect, a touchscreen device implementing the method above is provided.

In accordance with yet another aspect, a device driver implementing the method above is provided.

In accordance with yet a further aspect, a method for processing touch sensor data is provided. The method comprises obtaining a touch image from the touch sensor, the touch image comprising a plurality of active pixels, each of the active pixels indicating a sensor response, extracting one or more touch blobs from the touch image, combining a subset of the touch blobs predicted to correspond to a palm touch. The combination comprises, for each respective touch blob of the touch blobs, extracting spatiotemporal features from the respective touch blob, the spatiotemporal features comprising at least a location and an age of the respective touch blob, generating a feature embedding corresponding to the spatiotemporal features by a blob combination neural encoder, and for each respective pair of touch blobs of the touch blobs, predicting whether the pair of touch blobs corresponds to a single palm.

In accordance with yet another aspect, a touchscreen device implementing the method above is provided.

In accordance with yet a further aspect, a device driver implementing the method above is provided.

In accordance with yet another aspect, a method for processing touch sensor data is provided. The method comprises obtaining a touch image from the touch sensor, the touch image comprising a plurality of active pixels, each of the active pixels indicating a sensor response, further comprising identifying at least one hover by performing temporal smoothing of the touch image based on the past touch images, and predicting that a region of the touch image corresponding to the hover corresponds to a palm touch.

In accordance with yet a further aspect, a touchscreen device implementing the method above is provided.

In accordance with yet another aspect, a device driver implementing the method above is provided.

In accordance with yet another aspect, a method for processing touch sensor data is provided. The method comprises obtaining a touch image from the touch sensor, the touch image comprising a plurality of active pixels, each of the active pixels indicating a sensor response, extracting one or more touch blobs from the touch image, computing at least one gradient from a gradient a variation over time of the indicated sensor response for each of the touch blobs and at least one gradient of a variation over at least one spatial dimension of the indicated sensor values for each of the touch blobs, and predicting whether each of the touch blobs corresponds to an intentional finger touch or to an intentional finger touch based at least in part on the at least one gradient.

In accordance with yet a further aspect, a touchscreen device implementing the method above is provided.

In accordance with yet another aspect, a device driver implementing the method above is provided.

In accordance with yet a further aspect, a method for processing touch sensor data is provided. The method comprises obtaining a touch image from the touch sensor, the touch image comprising a plurality of active pixels, each of the active pixels indicating a sensor response, extracting one or more touch blobs from the touch image, predicting whether each of the touch blobs corresponds to an intentional finger touch or to a palm touch, extracting spatial features from the each of the touch blobs predicted to correspond to an intention touch, the spatial features comprising at least a location and a shape, and estimating a hand model to predict the probability that an input blob image corresponds to an intentional finger touch or a palm touch based on the spatial features, wherein predicting whether a further touch blob corresponds to an intentional or a palm touch is based at least in part on the hand model.

In accordance with yet another aspect, a touchscreen device implementing the method above is provided.

In accordance with yet a further aspect, a device driver implementing the method above is provided.

In accordance with yet another aspect, a method for processing touch sensor data is provided. The method includes obtaining a touch image from the touch sensor, the touch image comprising a plurality of active pixels, each of the active pixels indicating a sensor response, extracting one or more touch blobs from the touch image, and predicting for each respective touch blob whether the respective touch blob corresponds to an intentional finger touch or to a palm touch based at least in part on context provided by the one or more touch blobs and/or previous touch blobs.

In accordance with yet a further aspect, a touchscreen device implementing the method above is provided.

In accordance with yet another aspect, a device driver implementing the method above is provided.

In accordance with yet a further aspect, a method for processing touch sensor data based on a first and second thresholds is provided. The method implements a region-of-interest predictor. The method comprises obtaining a touch image from the touch sensor, the touch image comprising a plurality of active pixels, each of the active pixels indicating a sensor response, generating a graph in which each of the vertices is associated with an active pixel, traversing the graph to identify one or more subgraphs connected through connecting vertices associated with a sensor response above the first threshold, continuing traversing the graph to expend the subgraphs until a cutoff condition associated with a second threshold and related to a current vertex and a previous vertex is met, and generating one or more touch blobs, each corresponding to one of the subgraphs.

In accordance with yet another aspect, a touchscreen device implementing the method above is provided.

In accordance with yet a further aspect, a device driver implementing the method above is provided.

In another aspect, the present application discloses a non-transitory, computer-readable medium storing instructions that, when executed by a processor in a device, cause the processor to implement any of the methods disclosed herein.

In another aspect, the present application discloses a device that is configured to perform any of the methods disclosed herein.

In another aspect, the present application discloses a processor that is configured to execute instructions to cause a device to perform any of the methods disclosed herein.

In another aspect, the present application discloses an integrated circuit that is configured to perform any of the methods disclosed herein.

In another aspect, the present application discloses a module comprising one or more circuits for performing any of the methods disclosed herein.

In another aspect, the present application discloses an apparatus comprising one or more processors functionally connected to a memory for performing any of the methods disclosed herein.

In another aspect, the present application discloses an apparatus that is configured to perform any of the methods disclosed herein.

In another aspect, the present application discloses non-transitory, computer-readable storage media storing instructions that, when executed, cause at least one processing unit, at least one processor, or at least one circuit to perform any of the methods disclosed herein.

In another aspect, the present application discloses a computer program product including instructions that, when executed by an apparatus, enable the apparatus to implement any of the methods disclosed herein.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 is a schematic of a computing device, including a touchscreen device, in accordance with an embodiment.

FIG. 2 is a flowchart of a method for processing touch sensor data, in accordance with an embodiment.

FIG. 3A is a flowchart of a method for processing touch sensor data, in accordance with an embodiment.

FIGS. 3B, 3C and 3D are illustrations of touch images with extracted touch blobs, in accordance with three embodiments.

FIG. 3E is an enlarged view of a portion of FIG. 3D.

FIGS. 3F1 to 3F5 are illustrations of a touch image at various stages of extrating touch blobs, in accordance with an embodiment and an example.

FIGS. 4A and 4B are schematics of systems for processing touch sensor data, in accordance with two embodiments.

FIG. 5A is a schematic of a system for processing touch sensor data, in accordance with an embodiment.

FIG. 5B is an illustration of a touch image with extracted touch blobs, in accordance with the embodiment depicted in FIG. 5A.

FIG. 5C is an enlarged view of a portion of FIG. 5B.

FIG. 6A is a flowchart of a method for processing touch sensor data, in accordance with an embodiment.

FIGS. 6B and 6C are illustrations of touch images with extracted touch blobs, in accordance with two embodiments.

FIG. 7 is a schematic of a system for estimating a hand model, in accordance with an embodiment.

FIG. 8 is an illustration of a touch image with extracted touch blobs, in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In the present disclosure, a “region-of-interest” is understood as a free flowing graph of pixels, i.e., not a fixed shape, and a “blob image” is understood as a rectangle enclosing a region-of-interest. The blob could or could not be an axis-aligned image patch. It could or could not be a tight rectangle box around the corresponding region-of-interest.

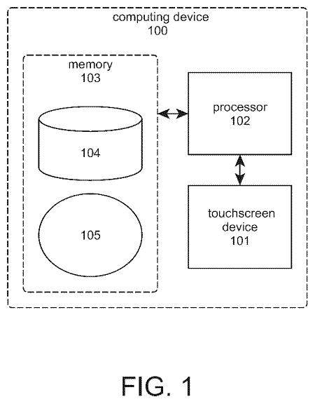

With reference to FIG. 1, an exemplary rendering environment is depicted, including rendering device 100. The device 100 may be any suitable computing device, such as, but not limited to, mobile computing devices such as phones, smart phones, tablets, laptop computers, handheld and/or wearable devices, and the like, or fixed computing devices, such as desktop computers, servers, kiosks, and the like. The device 100 includes a touchscreen device 101, at least one processor 102, memory 103.

The touchscreen device 101 can be any electronic device configured to detect touch inputs via a touch-sensitive interface and process corresponding touch sensor data, i.e., any electronic signals, measurements, or data structures generated by touch sensors representing one or more touch events and including, for instance, raw voltage or current values, capacitance measurements, optical signal variations, positional coordinates, pressure levels and/or timing information, each of which can reflect a corresponding sensor response to user interaction with the touch-sensitive surface. In some embodiments, the touchscreen device 101 can incorporate one or more touch-sensitive surfaces defining a touch sensor, which can include, for example, a capacitive touch panel, a resistive touch panel, an optical touch sensor, a surface acoustic wave (SAW) sensor, or any other suitable type of touch detection technology. As an example, an optical touch sensor can include one or more infrared light emitters and corresponding photodetectors arranged along the edges of a display surface to detect interruptions in light beams caused by a user's fingers or palms, and can further include implementations based on diffused infrared imaging, frustrated total internal reflection, or optical waveguide techniques, e.g., using corner-mounted cameras and light sources to triangulate touch positions. The touchscreen device 101 can also include additional components such as a display for presenting visual content to a user, one or more processors for executing instructions and processing touch sensor data, memory for storing data and instructions, communication interfaces for exchanging data with external systems, and power management circuitry. In some embodiments, the touchscreen device 101 can be configured to obtain a touch image from the touch sensor, where the touch image comprises a plurality of active pixels. Each active pixel can indicate a sensor response corresponding to a particular location on the touch-sensitive surface. For example, in the case of a capacitive touch panel, the touch image can be called a capacitive image, and the sensor response of an active pixel can represent a change in capacitance detected at a specific intersection of drive and sense lines. In other examples, such as with a resistive touch panel, the sensor response of an active pixel can indicate a change in voltage or resistance caused by a physical press. In some embodiments, a touch image can represent a snapshot of sensor data collected over the entire touch-sensitive surface at a given moment, allowing the touchscreen device 101 to detect one or more touch events, such as taps, swipes, multi-finger gestures, or stylus interactions. The touch image can be stored in memory 103 to be processed by the processor 102. It should be understood that the term “active pixel” is not limited to any particular sensor architecture and can broadly refer to any discrete sensing element, measurement point, or logical unit within the touch sensor that generates or contributes to the sensor response data of the touch image.

The processor 102 may include a central processing unit (CPU), a microcontroller, a microprocessor, a processing core, a field-programmable gate array (FPGA), a graphics processing unit (GPU), or similar. The processor 102 may include multiple cooperating processors. The processor 102 may cooperate with the memory 103 to realize the functionality described herein.

The memory 103 may include a combination of volatile (e.g., Random Access Memory or RAM) and non-volatile memory (e.g., read-only memory or ROM, Electrically Erasable Programmable Read Only Memory or EEPROM, flash memory). All or some of the memory 103 may be integrated with the processor 102. The memory can store data 104 as well as applications 105, each including a plurality of computer-readable instructions executable by the processor 102. The execution of the instructions by the processor 102 configures the device 100 to perform actions discussed herein. In particular, the applications 105 stored in the memory 105 can include applications to render frames. When executed by the processor 102, the applications 105 configure the processor 102 and/or the device 100 to perform various functions discussed in greater detail below.

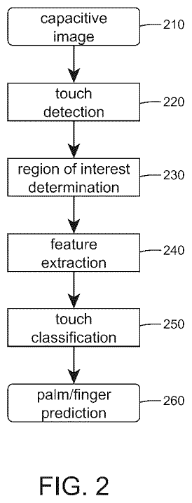

With reference to FIG. 2, an exemplary method for processing touch sensor data is illustrated. Broadly described, the method can include obtaining a capacitive image, detecting touches in the image, determining a region of interest for each touch, extracting features from each region of interest, classifying the touches, and predicting whether each touch is an intentional finger touch or an accidental touch.

The method can include a step 210 of obtaining a touch image such as a capacitive image from the touch sensor of a touchscreen device. The image can include a plurality of sensor measurements captured over the touch-sensitive surface, where each measurement corresponds to a particular location on the surface and indicates a capacitive response. In some embodiments, the capacitive image can be generated by sampling signals from a grid of electrodes, such as a matrix of drive and sense lines, and can represent the instantaneous distribution of capacitance across the touch-sensitive surface.

At step 220, the method can include detecting touches, also called blobs, in the capacitive image. Detecting touches can involve identifying areas within the capacitive image where the sensor responses exceed a predefined threshold, exhibit specific spatial patterns, or meet other criteria indicative of physical contact with the touch-sensitive surface. In some embodiments, the detected touches can include individual points of contact, such as fingertips, or larger areas of contact, such as parts of a palm resting on the screen.

At step 230, the method can include determining a region of interest associated with each detected touch. In some embodiments, a region of interest can define a subset of the capacitive image surrounding or encompassing the detected touch. The region of interest can be defined using various techniques, such as applying a bounding box, a contour, or a convex hull around the touch, or by expanding a fixed radius from the touch's central location. In some embodiments, the touch's central location can be extended based on another, smaller threshold. In some embodiments, the size and shape of the region of interest can vary based on characteristics of the detected touch, such as its amplitude, area, or proximity to other touches.

At step 240, the method can include extracting features from each region of interest. These features can include, for example, geometric features (such as width, height, area, and aspect ratio), statistical features (such as the mean, variance, maximum, and minimum sensor responses within the region), and shape descriptors (such as circularity, elongation, or convexity). In some embodiments, temporal features can also be extracted by analyzing how the region of interest evolves over time across successive capacitive images. Extracted features can provide descriptive information about the physical characteristics of each touch and can serve as inputs for further processing stages.

At step 250, the method can include classifying the touches based on the extracted features. In some embodiments, classification can involve applying a rule-based approach, a machine learning model, or a combination thereof to determine a category or label for each touch. For example, touches can be classified as finger touches, palm touches, stylus touches, or other types of contact events. In some embodiments, classification can be performed using a neural network, a decision tree, a support vector machine, or other suitable algorithms trained on previously collected touch data.

At step 260, the method can include predicting whether each touch is an intentional finger touch produced, e.g., by the finger of the user or an accidental touch produced, e.g., by the user's palm. In some embodiments, this prediction can be based on the classification results from step 250, the extracted features from step 240, or both. For instance, touches with features characteristic of large, low-pressure areas may be predicted as accidental palm touches, while smaller, well-defined touches with higher pressure may be predicted as intentional finger touches. In some embodiments, the prediction can be binary (intentional or accidental) or can include a confidence score or probability associated with each prediction. Such predictions can be used to suppress accidental inputs, improve gesture recognition accuracy, and enhance the overall user experience.

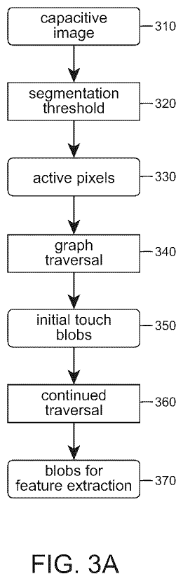

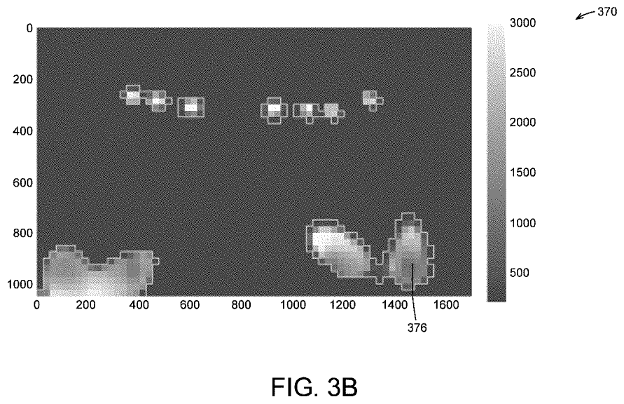

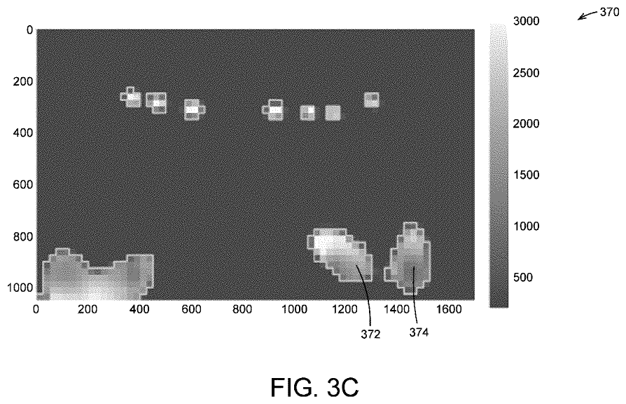

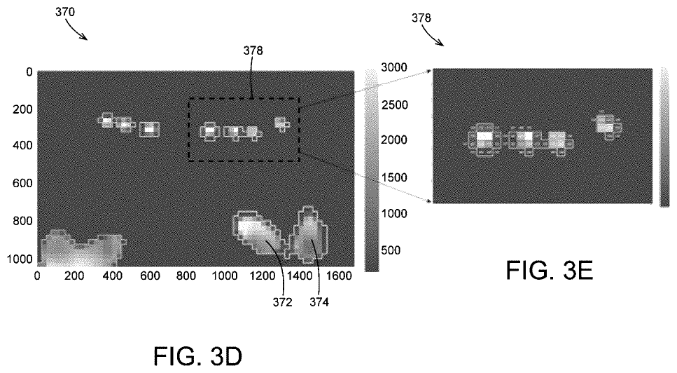

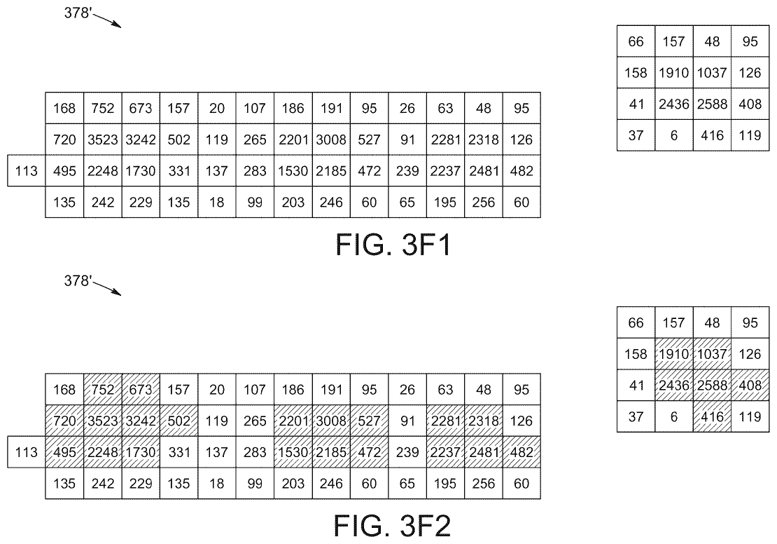

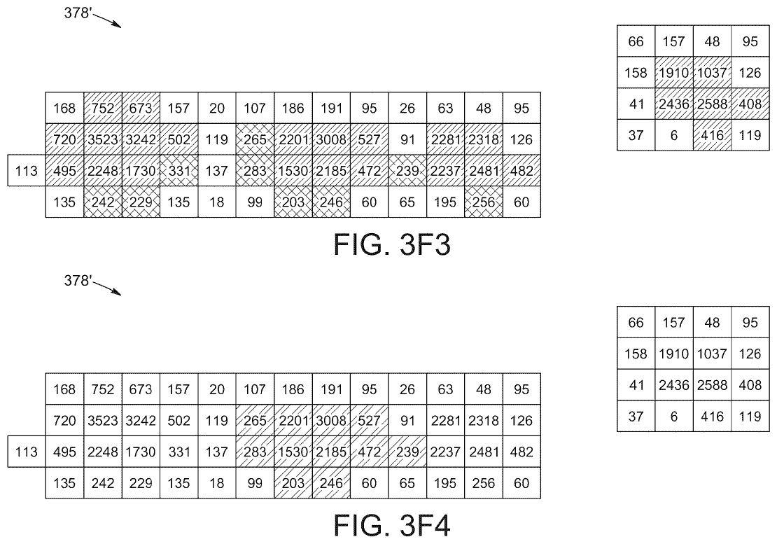

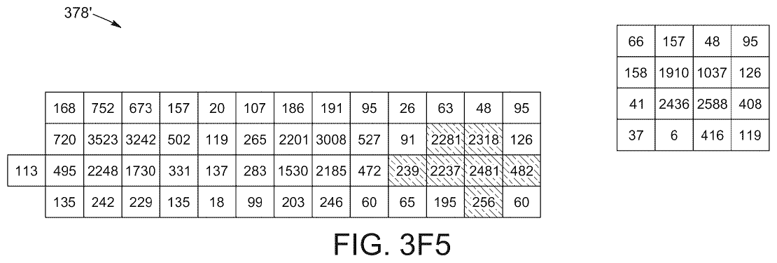

It should be understood that the steps of the method described above are not limited to the particular order shown in FIG. 2 and can be performed in any suitable sequence or combination. Moreover, additional steps can be included, or certain steps can be omitted, without departing from the scope of the present disclosure. Examples are provided below with reference to FIGS. 3A to 8.

With reference to FIGS. 3A to 3E, a more complex exemplary method for processing touch sensor data based on two thresholds is illustrated. The method delimits touch blobs, i.e., contiguous regions or groupings of touch sensor data that are interpreted as corresponding to a single touch event or contact area on the touch-sensitive surface, and thereby implements a region-of-interest predictor. As used herein, a region-of-interest can refer to a subset of the touch-sensitive surface or of the touch sensor data that is selected for further refinement, processing and/or classification of an input event, and can for instance be defined spatially based on the location and extent of a detected touch blob. Broadly described, it can include obtaining a capacitive image, performing a graph traversal based on a first threshold to detect initial touch blobs in the image, and continuing the graph traversal based on a second threshold to obtain blobs that define a region-of-interest associated with a touch and that are suitable for feature extraction.

The method can include a step 310 of obtaining a capacitive image from the touch sensor of the touchscreen device, which can be implemented in a way similar to step 210 shown in FIG. 2 and described above. The capacitive image can include a plurality of pixel responses, each representing a capacitive measurement at a specific location on the touch-sensitive surface, expressed, for example, in femtofarads (fF) or equivalent digital values indicative of capacitance changes. Although the method is illustrated with reference to a capacitive image, it can be appreciated that other types of touch images can be used, such as, for instance, a resistive image generated by the sensors of a touch panel, in which case the pixel response can be expressed in units, for example, corresponding to the voltage, e.g., millivolts, resistance, e.g., ohms, and/or digital raw values representing sampled signal levels from the sensor circuitry.

At step 320, the method can include determining a first segmentation threshold. In some embodiments, the first threshold can be a predefined or dynamically computed capacitance value used to distinguish between background noise and meaningful touch activity. The first threshold can be selected based on factors such as device calibration data, recent environmental conditions, or statistical properties of the capacitive image, such as the mean or standard deviation of pixel responses. As examples, the first threshold can correspond to a value between 10 fF and 200 fF for a capacitive sensor, or between 5 mV and 100 mV for a resistive sensor.

At step 330, the method can include generating an active pixel graph. The graph can include a set of vertices, including one vertex corresponding to each pixel. Each vertex can be decorated with its associated pixel response. As an example, the decoration can correspond to a label including a numeric or ordinal value indicating the sensor response. The value associated with the decoration of each vertex can be used to guide the graph traversal. The graph can additionally include a set of edges, including one edge to connect each pair of vertices corresponding to two adjacent pixels. In some embodiments, adjacency can be defined based on direct neighbours in the capacitive image, such as the four orthogonally adjacent pixels (in a 4-connected graph) or the eight surrounding pixels (in an 8-connected graph).

At step 340, the method can include traversing the graph to identify subgraphs of connected vertices, which can also be called components, i.e., groups of adjacent pixels, that are determined to be activated based on the first threshold. In some embodiments, a pixel can be considered activated if its response exceeds the first threshold, and a subgraph can be formed by recursively grouping all activated pixels that are connected through adjacency relationships.

At step 350, the method can include determining that the subgraphs identified in step 340 correspond to “initial” touch blobs. In some embodiments, each such touch blob represents a candidate touch region identified solely based on the presence of connected activated pixels. However, it can be appreciated that the quality and accuracy of the identified touch blobs are highly sensitive to the value of the first threshold. The quality of touch segmentation, i.e., differentiating the touch region into one or more region-of-interest based on different fingers touching the screen, can be particularly problematic in conditions where the touch sensor has a low resolution or when two or more touches, e.g., from multiple fingers.

If the first threshold is set too low, background noise or minor variations in capacitance can cause separate touches to be merged into a single, oversized blob, such as blob 376 shown in FIG. 3B, potentially masking the presence of multiple distinct touches. Conversely, if the first threshold is set too high, only the strongest portions of each touch may be captured, causing active pixels near the boundary of a touch to be excluded and potentially fragmenting a single touch into multiple smaller, incomplete blobs, such as blobs 372 and 374 shown in FIG. 3C, based on the same capacitive image as FIG. 3B.

It can be appreciated that, in practice, careful tuning of the first threshold is often insufficient to achieve reliable and consistent segmentation of touch regions across a wide range of operating conditions. This is because the optimal value of the first threshold can vary significantly depending on factors such as the specific touch sensor hardware, the physical characteristics of the touches such as for example, finger size, pressure, and contact angle, and environmental influences such as temperature, humidity, or electrical noise. A threshold that works well under certain conditions can lead to excessive merging of touches when capacitance values are elevated or, conversely, to the loss of weak or peripheral signals when capacitance values are reduced. As a result, relying solely on static or even adaptive tuning of the first threshold often fails to provide robust segmentation in real-world usage scenarios.

To address these limitations, in some embodiments, the method can include a step 360 of continuing the traversal based on a second, smaller threshold. The continued traversal can include expending subgraphs by adding vertices until a cutoff condition is met. One or more cutoff conditions can be defined. Each cutoff condition can be related to a vertex that is part of a subgraph and that was just visited, which can be called the previous vertex, and a vertex that is being evaluated for possible inclusion in the subgraph of the previous vertex, which can be called the current vertex. As an example, a cutoff condition can include the current vertex being decorated with a sensor response value greater than the sensor response of the previous vertex. As another example, a cutoff condition can include the current vertex already being part of one of the subgraphs or components, e.g., another subgraph. It can be appreciated, with respect to the preceding example, that different points in the process can be considered for marking a vertex to be part of existing components. For instance, when continuing the traversal, for all the vertices in the graph, the first neighbour vertex is added to a set of visiting vertices. If the value is above the second threshold, it can be included in the region-of-interest of the touch and marked node as visited. In some embodiments, only once the first neighbours of all the vertices in the graph has been explored, all the nodes in this visiting set are marked visited, i.e., are considered to be part of one touch component for the purposes of the preceding condition. It can be appreciated that, at this point, some vertices may belong to more than one touch. This advantageously provides region-of-interest delimitation to be deterministic, irrespective of the actual order in which each component identified during the initial traversal is processed. As a further example, a cutoff condition can include the current threshold being decorated with a sensor response value lower than the second threshold.

In step 370, the subgraphs that have potentially been expended by the continued traversal of step 360 can be determined to correspond to “final” touch blobs, indicative of the true region-of-interest associated with each touch, from which features can be extracted to allow for a more accurate classification of intentional and accidental touches. It can be appreciated that the quality and accuracy of the identified touch blobs are enhanced by the use of a dual threshold method, as can be seen for instance in FIG. 3D, based on the same capacitive image as FIGS. 3B and 3C, but where blobs 372 and 374 are determined to be distinct, unlike in FIG. 3B, while including all relevant pixels in the region-of-interest, unlike in FIG. 3C. Region 378, including four well-defined, smaller blobs, is enlarged in FIG. 3E, and demonstrates that nearby touches from multiple fingers can be accurately segmented as multiple touches using the disclosed method. This also allows using every pixel of capacitive sensor that is potentially being affected by a touch and yield to improved feature extraction, and therefore improved classification. In some embodiments, the region-of-interest used for feature extraction can overlap between multiple touches.

With reference to FIGS. 3A and 3F1 to 3F5, an exemplary performance of method 300 on a region 378′ of a capacitive image obtained in step 310 is illustrated. In FIG. 3F1, the capacitance image region is represented as a grid in which each cell or pixel corresponds to a sensing element and includes a sensor response indicative of the local capacitive variation at that location. Step 320 can include receiving a first threshold value of 400. A first graph traversal performed in step 340 using breadth-first search based on the first threshold value will result in the pixels identified by dash lines in FIG. 3F2 being visited, with four initial touch blobs being identified in step 350. Graph traversal can be continued in step 360 still using breadth-first search, resulting in additional pixels identified by double dash lines in FIG. 3F3 being visited, allowing for a better definition of the four touch blobs that is ready for further processing being determined in step 370. As illustrated in FIGS. 3F4 and 3F5, identifying two distinct blobs, method 300 can result in overlapping occurring.

It can be appreciated that, while a specific implementation of a region-of-interest detector is provided with reference to FIGS. 3A to 3F5, other suitable region-of-interest detectors can be used to identify touch blobs and/or regions-of-interest in touch sensor data to implement the methods and systems described below. As examples, a region-of-interest predictor can detect and/or delimit touch blobs and/or regions-of-interest from touch sensor data using a variety of techniques, including thresholding methods that identify sensor activations exceeding a predefined intensity or pressure value, clustering algorithms such as k-means or DBSCAN that group spatially or temporally proximate sensor activations, connected-component analysis applied to a binarized activation matrix, and simple graph traversal techniques, such as depth-first search or breadth-first search, applied to a graph representation of the touch sensor grid where activated nodes are connected based on spatial adjacency. In some embodiments, regions-of-interest can be further refined using edge detection filters, morphological operations such as dilation or erosion, or motion vector analysis to distinguish dynamic touch events from stationary contacts. Additional approaches can include the use of machine learning classifiers trained to recognize blob-like structures within sensor matrices, heuristic rules based on minimum and/or maximum blob size constraints, region-growing algorithms that expand from seed points based on local sensor intensity gradients or continuity of activation, and temporal filtering to aggregate touch activity over short time windows.

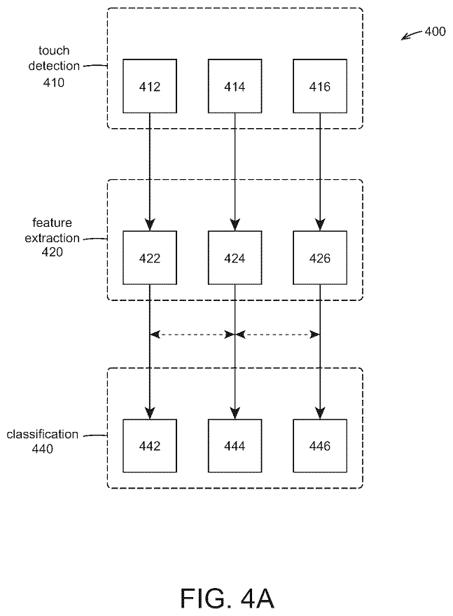

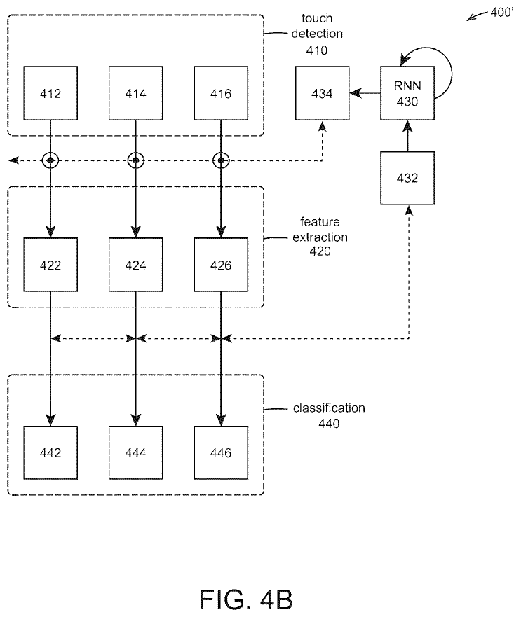

With reference to FIG. 4A, an exemplary system 400 for processing touch sensor data is illustrated. The features of a single touch blob may not provide sufficient information to conclusively classify it as an intentional finger touch or not. Broadly described, system 400 relies on spatial context, i.e., the geometric, positional, and relational features of a touch, as derived from the spatial arrangement and characteristics of all detectable touches within the same frame of sensor data. This can for instance include the relative positions, distances, and orientations between the touch of interest and other simultaneously detected touches, the pattern, density, and clustering of adjacent touches (e.g., their centroid coordinates, bounding box dimensions etc.), and/or topological relationships such as proximity to edges or corners of the touchscreen, to determine whether each given touch is intentional or not. System 400 can rely on spatial attention, e.g., using information from other touches. The ability to use information provided by every touch improves the classification results when the independent classification of individual touches is ambiguous. By taking a more holistic approach and considering the relationships between multiple touches, if any, to estimate the spatial structure of the hand system 400 can gain a more comprehensive understanding of the touch patterns, advantageously enhancing the accuracy and confidence of touch classification.

System 400 includes a touch detection module 410 configured to obtain blob images 412, 414, and 416, each corresponding to a region of interest associated with one blob identified by a region-of-interest predictor. As an example, the region-of-interest predictor described above with reference to FIGS. 3A to 3E can be used. However, it can be appreciated that any suitable method or system capable of identifying touches and predicting a region of interest for each touch can be used. For example, in some embodiments, the region-of-interest predictor can rely on graph-based segmentation using a single threshold or dual thresholds, while in other embodiments, alternative techniques such as connected component analysis, contour detection, clustering algorithms, or machine learning models trained to localize touch areas can be employed. The blob images 412, 414, and 416 can include subsets of the original capacitive image corresponding to the respective regions of interest and can preserve the raw pixel responses or include preprocessed data such as normalized capacitance values, filtered signals, or feature-enhanced representations.

System 400 further includes a feature extractor 420 configured to extract features 422, 424, and 426 from the respective blob images 412, 414, and 416. The feature extractor 420 can be implemented using classical feature extraction techniques, neural networks, or a combination thereof. In some embodiments, the feature extractor 420 can compute a set of interpretable features from each blob image, for instance, to characterize the shape, size, intensity, and spatial distribution of the active pixels. For example, geometric features can include the width and height of the blob, the aspect ratio, e.g., computed as the ratio of width to height, and/or the total area, e.g., obtained by counting the number of active pixels within the blob. Still for example, statistical features can include the maximum, minimum, mean, and/or standard deviation of the pixel responses within the blob image. Still for example, boundary-based features can include the convex hull area, the perimeter length of the outer contour of the blob, and/or measures of circularity or elongation based on the distribution of the blob's active pixels. These features can be extracted using well-established image processing techniques, such as thresholding, connected-component labelling, contour tracing, and moment calculations, providing interpretable metrics that can help differentiate between different types of touches.

As used herein, a neural encoder can refer to a neural network or a neural network component trained to transform raw or structured input data such as features derivef from touch blob images into a learned representation in a latent feature space, also named a feature vector embedding, or simply a feature vector, feature embedding or vector embedding, that captures salient characteristics of the input for subsequent processing, comparison and/or classification. In some embodiments, the feature extractor 420 can include or be implemented as a neural encoder configured to process each blob image 412, 414, 416 and output a corresponding vector embedding that represents the learned features 422, 424, 426 of the input image. As an example, the feature extractor 420 can transform each blob image into a fixed-length numerical vector, where each dimension of the vector captures some learned aspect of the blob's visual pattern.

In some embodiments, the neural encoder can include a series of convolutional layers designed to progressively extract spatial hierarchies of features from each blob image by applying learned filters across the input data. These convolutional layers can capture local patterns, such as edges, peaks, and ridges of capacitance within the blob. In some embodiments, the neural encoder can further include at least one dense, i.e., fully connected, layer, which can integrate the spatial features extracted by the convolutional layers into a compact embedding vector. This architecture can allow the encoder to model complex relationships between features and generate rich, high-level representations of the blob images suitable for use in downstream tasks, such as touch classification.

In some embodiments, the neural encoder can further output, for each blob image, a query, keys, and values suitable for implementing an attention mechanism. These outputs can enable attention-based models to compare and weigh the relationships between multiple blobs, prioritize certain features over others, or aggregate contextual information across blobs to make predictions.

As used herein, a context vector can refer to an output representation generated by an attention head in a transformer architecture, which encodes a weighted combination of input feature vectors, i.e., the values, based on their learned pairwise relevance to a given query, thereby capturing contextual relationships among touch blobs or between different input modalities. In the case of cross-attention, the query is derived from one input sequence, e.g., a representation of a given touch blob, while the keys and values can be derived from a separate input sequence, e.g., a set of other, previously and/or contemporarily observed touch blobs, allowing the context vector to integrate information across different blobs and/or times.

In some embodiments, the system 400 can further apply a cross-attention mechanism to compare and relate features extracted from multiple blob images. Cross-attention can enable the system to compute context-aware representations by allowing the features of one blob to selectively attend to, or focus on, relevant features from other blobs. In general, cross-attention operates by using a set of queries derived from one blob's features and comparing them with keys derived from other blobs' features, computing attention-based weighted combinations of the values based on the similarity between the queries and keys. This allows the system to dynamically prioritize and integrate information across blobs, capturing inter-blob dependencies and contextual relationships that can improve downstream tasks such as classification, touch grouping, or intent prediction. Cross-attention can be particularly useful in handling complex and potentially ambiguous touch interactions where the interpretation of one touch may depend on the properties and positions of nearby touches.

The system 400 includes a classifier 440 trained to receive feature representations of blob images 422, 424, 426, such as vector embeddings produced by the feature extractor 420 and/or attention heads, and output a corresponding class prediction for each blob. In some embodiments, the classifier 440 includes an attention block and/or one or more dense layers that process the input features and produce outputs such as class scores, probabilities, or labels. In some embodiments, a cross-attention context vector for one given blob image can be computed based on its query q, the keys K of each of the blob images and the values V of each of the blob images, for instance using attention function

$$\frac{{e}^{q \cdot {K}_{i}}}{{\sum }_{j = 1}^{n} {e}^{q \cdot {K}_{j}}} {V}_{i} .$$

In some embodiments, the classifier assigns each blob to a category such as an intentional finger touch and an accidental touch. In some embodiments, the classifier can apply an activation function, such as a softmax or sigmoid function, to generate normalized scores representing the likelihood of each possible class. The classifier can be trained using supervised learning techniques, where known examples of blob images are labelled with their correct class, allowing the system to learn patterns that distinguish between different types of touches. It can be appreciated that the structure of the classifier is not limited to a specific architecture and can include additional components, such as dropout layers, batch normalization, or residual connections, depending on the complexity of the task and the desired level of generalization.

In some embodiments, the classifier 440 produces a feature map or a set of per-blob or per-pixel class scores 442, 444, 446 that capture the likelihood of different touch types or categories across spatial dimensions, and the output of the attention block is used as input to a pooling layer, e.g., a maxpool layer over attention values. This pooling operation can help emphasize the strongest signals associated with each blob, provide translational invariance, and reduce the computational complexity of subsequent processing stages. In some embodiments, the pooling layer can aggregate information across multiple blobs or over the spatial extent of a single blob to produce a compact summary that can be used for final decision-making, such as determining whether any detected touch is likely accidental or intentional, or identifying the overall type of interaction occurring on the touch-sensitive surface.

The output of the attention block or of the pooling layer, or, in some embodiments, the same output passed through a softmax layer, can include a probability that a given blob image 412, 414, 416 corresponds to an intentional finger touch and a probability that the given blob image 412, 414, 416 corresponds to an accidental touch. These probabilities can be used to perform a prediction of whether a given blob image 412, 414, 416 corresponds to an intentional finger touch if the predicted probability that the blob image corresponds to an intentional finger touch is greater than the predicted probability that the blob image corresponds to a palm touch such as an intentional or accidental palm touch.

With reference to FIG. 4B, an exemplary system 400′ for processing touch sensor data is illustrated. Broadly described, system 400′ includes the features of system 400 illustrated in FIG. 4A and described above, and additionally makes use of the temporal context, i.e., the historical behaviour and evolution of a touch, derived from its previous states tracked over multiple frames of sensor data, including for instance the duration of the touch (e.g., transient vs. prolonged contact), the trajectory, velocity, or acceleration of the touch's centroid over time, including smoothness of motion, changes in geometric properties of the touch (e.g., size growth/decay, shape distortion, or capacitance signal dynamics), and/or temporal patterns such as repeated contact (e.g., typing rhythm) or static positioning (e.g., palm rest), by extracting hand pose information over time.

System 400′ can include a recurrent neural network 430 (RNN) configured to process sequences of data derived from touch sensor inputs, such as time-ordered series of capacitive images, sequences of extracted features from blob images, or temporal progressions of detected touches. The RNN 430 can include at least one hidden layer, which refers to an internal processing layer that maintains and updates a state vector over time based on both the current input and the previous state, thereby enabling the network to capture temporal dependencies and sequential patterns in the input data. In some embodiments, the RNN 430 is trained to process and extract information from a sequence of frames. The query, keys and values generated per touch can be conditioned on the sequential information captured by RNN 430 in hidden units of the hidden layer(s), corresponding to hidden states of the RNN 430. The number of blobs within a frame over a sequence of frames can vary. The features from all the blobs within a frame can be aggregated, for instance, by applying an additive pooling operation 432 or maxpool, e.g., in a classification head. An RNN can be designed to capture temporal dependencies by maintaining a hidden state that is updated at each time step based on the current input and the previous hidden state, allowing the network to model patterns that evolve over time. This makes RNNs particularly well suited for applications where the interpretation of a touch event depends on its dynamic behaviour, such as distinguishing between a brief tap and a sustained press, or recognizing gesture transitions like swipes or pinches. In some embodiments, the RNN 430 can be implemented using standard recurrent layers, such as vanilla RNN cells, or more advanced variants, such as Long Short-Term Memory (LSTM) networks or Gated Recurrent Units (GRUs), which are capable of capturing longer-term dependencies while mitigating issues like vanishing gradients. The output of the RNN 430 can include a sequence of predictions or a final aggregated representation summarizing the entire input sequence, which can be used for downstream tasks such as touch classification, gesture recognition, or intent prediction. In some embodiments, the output of the RNN 430 is passed through a multilayer perceptron, the output being provided as input to hidden unit 432.

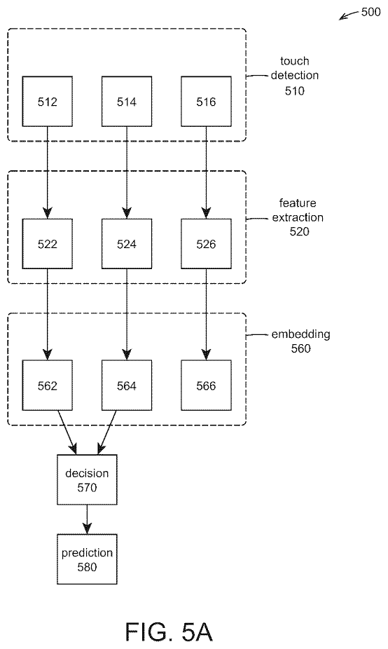

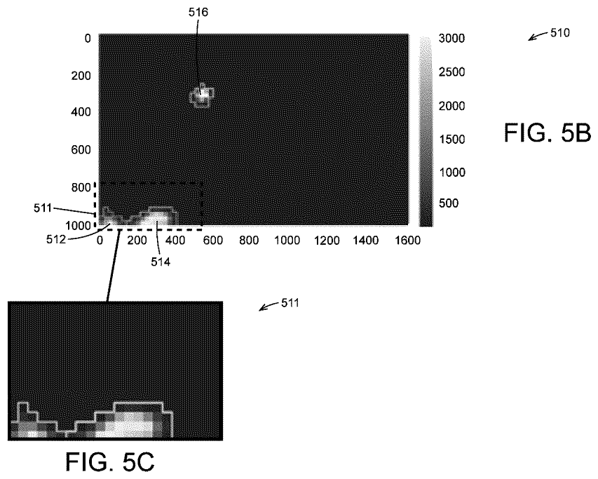

With reference to FIGS. 5A to 5C, an exemplary system 500 for processing touch sensor data is illustrated. In certain scenarios, a single palm can show up as multiple distinct touches, posing a challenge for accurate palm detection and tracking. Broadly described, system 500 exploits the spatial and temporal context to identify multiple touches that are likely to belong to the same palm. By recognizing the spatial correlation between these touches, system 500 can aggregate them into a single touch entity, facilitating more efficient tracking in subsequent frames. Notably, tracking the movement of a previously identified palm touch can be achieved at a lower computational cost compared to performing detection and classification on every frame, thereby optimizing system performance. It can be appreciated that system 500 can be used as a standalone system to predict whether two touches correspond to the same palm, or as a helper system, for instance to a system configured to predict whether a touch is intentional or not such as system 400 or 400′, illustrated in FIGS. 4A and 4B and described above.

System 500 includes a touch detection module 510 configured to obtain blob images 512, 514, and 516, each corresponding to a region of interest associated with one blob identified by a region-of-interest predictor, and a feature extractor 520 configured to extract features 522, 524, and 526 from the respective blob images 512, 514, and 516. As an example, detection module 510 and feature extractor 520 can be implemented in a similar manner to features 410, 420 of system 400 and 400′. In some embodiments, the extracted features can include spatiotemporal features, i.e., a combination of both spatial and temporal features including for instance the location and/or the age of the corresponding blob image.

The features 522, 524, 526 can be passed as input to an encoder 560 such as a neural encoder, which can be called a “blob combination neural encoder”, configured to encode them into corresponding vector embeddings 562, 564, 566. In some embodiments, the neural encoder can include a series of convolutional layers designed to progressively extract spatial hierarchies of features from each blob image by applying learned filters across the input data. These convolutional layers can capture local patterns, such as edges, peaks, and ridges of capacitance within the blob. In some embodiments, the neural encoder can include at least one dense, i.e., fully connected, layer, which can integrate the spatial features extracted by the convolutional layers into a compact embedding vector. In a pairwise manner, two such vector embeddings, e.g., 562 and 564, can be provided as input to a decision model 570 trained to output a prediction 580 of whether the two image blobs, e.g., 512 and 514, correspond to a palm touch, i.e., the touch of a single palm. Advantageously, if it is predicted that a subset of the image blobs such as image blobs 512 and 514 in region 511 as illustrated in FIGS. 5B and 5C correspond to a single touch, they can be combined, diminishing the number of blobs, which can diminish the computational resources required to classify the blobs and improve the accuracy of the classification.

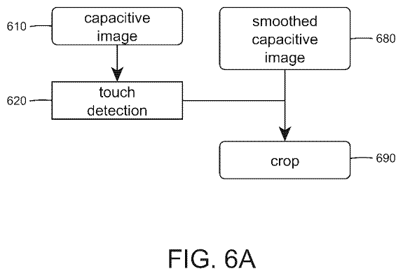

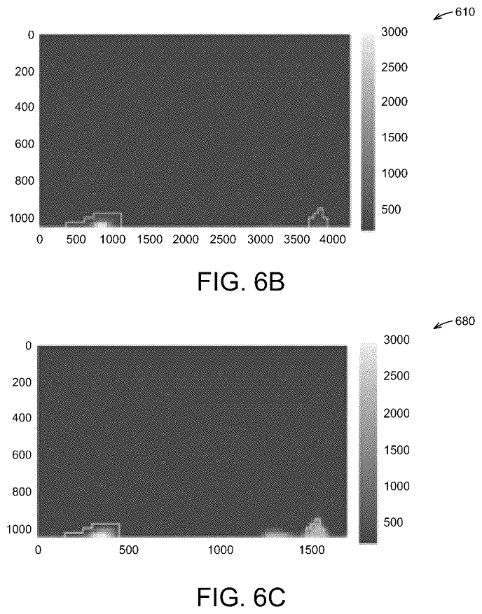

With reference to FIGS. 6A to 6C, an exemplary method for processing touch sensor data is illustrated. In some cases, not all parts of the palm may come into contact with the screen, making it challenging to detect the palm accurately. However, even when the entire palm is not in contact, a significant portion of it often remains in close proximity to the screen, particularly during activities such as virtual keyboard typing. Broadly described, the method allows for detection of this “hover” effect, which can be used to further enhance the accuracy and robustness of palm detection. It can be appreciated that the method can be used as a standalone method to compute smoothed blob images, or as a helper method, for instance to a system configured to predict whether a touch is intentional or not such as system 400 or 400′, illustrated in FIGS. 4A and 4B and described above.

The method can include a step of obtaining a touch image such as a capacitive image 610 from the touch sensor of a touchscreen device and a step 220 of detecting touches, also called blobs, which can be implemented in ways similar to steps 210 and 220 or 310 and 320 shown in FIG. 2 or 3A and described above.

The method can include a step of generating a smoothed image 680. The smoothed image 680 can incorporate hover information. As an example, the smoothed image can be generated through the use of a moving average and can be computed, for instance, at time t as Smoothed_Capₜ=α·Capₜ+(1−α)·Smoothed_Capₜ₋₁ using a configurable smoothing parameter α. In some embodiments, a smoothed image can additionally or alternatively be generated to implement spatial smoothing. In some embodiment, a smoothed image 680 is generated regardless of whether a touch is detected or not. This approach advantageously enables the system to infer hand structure and morphology even before a touch is registered, providing valuable context for improved palm detection and classification.

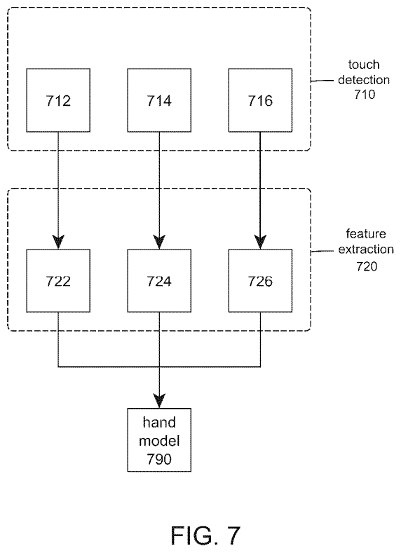

With reference to FIG. 7, an exemplary system for estimating a hand model 790 is illustrated. The hand model 790 can for instance include a dynamic probabilistic representation of the user's hand pose and contextual information inferred from capacitive sensor data. The model can vary in complexity—from a simplified scalar boundary separating palm and finger regions to a detailed skeletal representation (e.g., estimating bidimensional coordinates of landmarks like fingertips or palm centroid).

The system includes a touch detection module 710 configured to obtain blob images 712, 714, and 716, each corresponding to a region of interest associated with one blob identified by a region-of-interest predictor, and a feature extractor 720 configured to extract features 722, 724, and 726 from the respective blob images 712, 714, and 716. As an example, detection module 710 and feature extractor 720 can be implemented in a similar manner to features 410 and 420 of system 400 and 400′ or of features 510 and 520 of system 500, illustrated in FIGS. 4A to 5A and described above. In some embodiments, the extracted features can include the location and/or the size of the corresponding blob image.

Given the features 722, 724, 726 extracted from the blob images 712, 714, 716, a coarse hand model Φ 790 can be estimated and/or developed over time. Decision of a touch being accidental given the coarse over time model Φ 790 and a local model Θ can be determined for instance based on a weighted sum, i.e., a combination of probabilities from both models in which each value is multiplied by a corresponding weight, e.g., w or (1−w) before summation, for instance if w·P(accidental|Φ)+(1−w)·O(accidental|Θ)>w·P(intentional|Φ)+(1−w)·O(intentional|Θ). The score of hand model, p(Φ), is based on the long-term temporal features and spatial features. The confidence in the hand model 790 will be high when more touches are present and the change in information between frames is low, and vice versa. The weight w in above equation is a function of p(Φ), with w∝p(Φ).

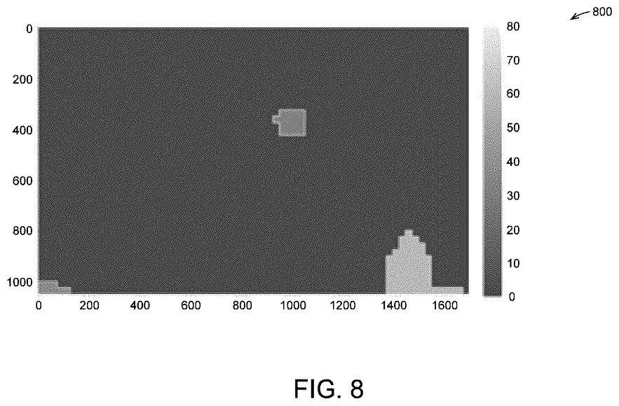

With reference to FIG. 8, a method for determining an average spatial smoothness is illustrated by way of its result. The spatial gradient and/or the spatial rate of change, for instance, along at least one spatial dimension, e.g., horizontally, vertically and/or diagonally, can be helpful features to classify a touch as intentional or accidental. FIG. 8 in particular illustrates applying average smoothness, i.e., ∝¹/_{gradient}. As it can be appreciated, the resulting gradient is high at the spatial boundary of the intentional, finger touch but low for the accidental, palm touch. Similarly, during the performance of tasks such as typing, the gradient will be high at the temporal boundary of finger touch and low for palm touch. The decision boundary for both spatial and temporal gradient, or smoothness, can be determined through user data and/or can be application specific.

One or more systems, methods, modules, steps or functionalities described herein may be implemented in computer programs executed on one or more processing devices, each comprising at least one processor, a data storage system (including both volatile and/or non-volatile memory and/or storage elements), and optionally at least one input and/or output device. These processing devices encompass a broad range of electronic systems capable of receiving, processing, and/or transmitting data. Examples of processing devices include, without limitation, general-purpose computers, specialized computing devices, and embedded systems. Processing devices may be implemented on dedicated hardware, including programmable hardware such as field-programmable gate arrays (FPGAs), or as software-based solutions on cloud computing platforms or serverless architectures.

Processing devices suitable for implementing the present disclosure may include programmable logic units, mainframe computers, servers, personal computers, laptops, cloud-based systems, personal digital assistants (PDAs), cellular telephones, smartphones, wearable devices, tablets, video game consoles, and portable video game devices. Each of these devices has the ability to execute instructions and can operate individually or in combination to perform the functionality described. The processing devices may be deployed in a variety of configurations, from single-device implementations to distributed systems that involve multiple devices collaborating to achieve a common purpose. For example, a method could be implemented on a single microcontroller in an embedded system, or distributed across a network of servers that share computational tasks.

The instructions that enable a processing device to perform a given method or function can be stored in the form of a computer program. This computer program may be implemented in a high-level programming language, such as an imperative language, including procedural or object-oriented languages like C++, Java, or Python, which are suited for a wide range of applications and can easily interface with various system components. High-level programming languages can also include declarative languages, such as functional languages like Haskell or logic languages like Prolog, which allow developers to specify what the program should accomplish rather than describing step-by-step operations. These high-level languages can improve development efficiency and code readability.

Alternatively, computer programs may be implemented in low-level languages, such as assembly or machine code, especially when direct hardware control or optimization is required. Low-level languages are closer to machine instructions and provide precise control over hardware resources, which can be advantageous in resource-constrained environments, such as embedded systems. Programs written in low-level languages can be used in applications that require high performance, small memory footprints, or real-time processing capabilities.

Each computer program may be either compiled or interpreted. Compiled languages, such as C or C++, can be transformed into machine code optimized for a specific hardware configuration, allowing efficient execution. Compilation can result in highly optimized executables that are tailored to the underlying architecture, which is advantageous in performance-critical applications. Interpreted languages, such as Python or JavaScript, offer flexibility by interpreting code at runtime. This allows for rapid development and platform independence, as the same code can be run on different systems with minimal modifications. Hybrid approaches, such as Java bytecode or .NET Common Intermediate Language (CIL), combine elements of both compiled and interpreted paradigms. In these cases, code is compiled to an intermediate representation that can be executed by a virtual machine on various platforms, providing cross-platform compatibility.

Each computer program implementing the methods or systems described herein is preferably stored on a computer-readable storage medium or device. Examples of such storage media include hard drives, solid-state drives, optical disks, flash memory, and magnetic tape. The computer-readable storage medium is readable by a general or special-purpose programmable computer, which, upon reading the instructions, can configure itself to perform the steps described herein. These instructions may include executable code, scripts, or markup that instructs the computer on how to operate and handle data, making the system or method functional. In some embodiments, the system or method may be embedded within an operating system running on a programmable computer, allowing for deeper integration with the hardware and enabling enhanced performance, security, or user interface features.

Processing devices implementing the present disclosure may contain a variety of hardware components that support program execution. Processors used within these devices include general-purpose central processing units (CPUs), which are capable of executing a wide variety of instructions, as well as specialized processors. Examples of specialized processors include graphics processing units (GPUs), which can be optimized for parallel processing and/or used in data-intensive applications like machine learning, digital signal processors (DSPs), which are designed for handling real-time audio, video, and other signal processing tasks, and application-specific integrated circuits (ASICs), which are tailored to specific functions and are often used in applications requiring high efficiency. Multi-core and/or multithreaded processors can allow for concurrent execution of multiple tasks, improving overall performance, for instance in multi-user or real-time environments.

The processing device may further include various types of memory. Volatile memory, such as registers, cache, and random-access memory (RAM), can be used for temporary data storage during active program execution, providing fast access to data that the processor frequently uses. Non-volatile memory, such as read-only memory (ROM), flash memory, solid-state drives, hard disks, and optical disks, can be used to retain data even when the processing device is powered off, making it suitable for long-term data storage. Other examples of non-volatile storage media include diskettes, magnetic tapes, chips, and compact disks, among others. The type of memory selected can depend on specific requirements, such as the need for rapid access, data retention, or data durability under power cycling. The memory configuration of a processing device can be adjusted to support varying levels of computational demand, from lightweight applications with minimal memory requirements to complex systems requiring large data caches.

Networking solutions within a processing device enable inter-process communication and network communication over wired or wireless connections. Examples of networking technologies include Ethernet for high-speed wired connections, Wi-Fi for wireless data transmission, Bluetooth for short-range device communication, and cellular networks for broader geographic coverage. These networking solutions support various network topologies, including local area networks (LAN), wide area networks (WAN), and other network types such as personal area networks (PAN) and metropolitan area networks (MAN), as well as the Internet. Through these networks, processing devices can communicate with one another to distribute tasks, share data, and collaborate on complex computations. This communication can occur within a single building or across geographically dispersed locations, depending on the application requirements.

Implementing networking security measures can be advantageous to protect data as it travels across potentially vulnerable channels. Key security principles can include confidentiality, integrity, and availability. Confidentiality can be achieved for instance through encryption protocols like Secure Sockets Layer (SSL) and Transport Layer Security (TLS), ensuring that data remains private. Integrity can be maintained for instance with cryptographic hashing and/or digital signatures, which can detect tampering, while availability can be protected for instance by redundancy, load balancing, and defences against denial-of-service (DoS) attacks. Access control mechanisms, including multifactor authentication and role-based access control, can be used to regulate network access. Network segmentation, such as virtual LANs (VLANs) and demilitarized zones (DMZs), can be implemented to limit access to sensitive areas and reduces the impact of breaches, while firewalls filter traffic based on predefined rules, providing an essential barrier between internal and external networks.

Advanced security measures for networking can be implemented, for instance, including encryption for wireless networks through protocols like Wi-Fi Protected Access 3 (WPA3), which can prevent unauthorized access to Wi-Fi. Intrusion detection and prevention systems (IDS/IPS) can be used to monitor network traffic for malicious activity, while virtual private networks (VPNs) can be used to establish secure connections for remote access over public networks. Regular security assessments, such as penetration testing and vulnerability scanning, identify weaknesses, and security information and event management (SIEM) systems may be leveraged to provide real-time insights into potential threats. A layered security approach, or defence in depth, can combine multiple controls across different levels of the network, enhancing resilience against both internal and external attacks by creating multiple barriers that attackers must overcome.

Distributed computing is a possible implementation in which multiple processing devices work together to perform tasks described herein. For example, a method or a method step may execute within a single thread on one processing device or be distributed across multiple threads, cores, or processors on a single device or across multiple devices. Distributed computing can help implement parallelization, where tasks are split into smaller subtasks that are processed concurrently, significantly improving processing speed and efficiency. This approach is well suited to applications with high computational demands, such as data analysis, machine learning, and large-scale simulations. In some implementations, processors are located within a single physical location, while in others, they may be spread across multiple sites, allowing for redundant and resilient computing infrastructures.

Distributed computing can also be implemented within a cloud computing environment, offering flexibility and scalability. Cloud computing architectures enable the allocation of computational resources on demand, allowing tasks to utilize as many or as few resources as needed for efficient execution. For instance, a single computational process may span multiple virtual machines, distributed across data centres in different geographical locations, to achieve optimal performance and fault tolerance. By leveraging multi-tenant architectures and dynamic scaling, cloud platforms allocate resources only as needed, reducing idle computational power. Furthermore, this approach facilitates cost efficiency, as users pay only for the resources they consume. Additionally, cloud computing's ability to pool resources across large-scale infrastructure provides inherent redundancy and resilience, ensuring high availability for critical applications. Cloud computing can include employing containers and microservices to enhance resource efficiency and streamline deployment. Containers encapsulate applications and their dependencies in lightweight, portable units that can run consistently across different environments. This allows distributed computing tasks to be executed reliably across heterogeneous systems, reducing compatibility issues. Microservices architectures further divide applications into smaller, independently deployable services, each responsible for a specific functionality. These services can scale independently, ensuring that resources are allocated precisely where needed and minimizing waste. Together, containers and microservices enable more efficient use of computational resources, shorter deployment cycles, and improved fault isolation.

The systems and methods described herein can be distributed using edge computing architectures. Edge computing can introduce additional layers to distributed and cloud computing by bringing certain processing capabilities closer to data sources, such as sensors or devices in the industrial Internet of Things (IIoT). In this architecture, certain computational tasks can be offloaded to edge devices, such as gateways or local servers, reducing latency and minimizing the volume of data transmitted to centralized data centres. This approach can be particularly advantageous in IIoT applications where real-time decision-making can be critical, such as predictive maintenance, autonomous control systems, or industrial automation. By processing data locally, edge computing can reduce bandwidth requirements, enhance data privacy, and ensure continuity of operations even when connectivity to the cloud is intermittent. This integration of edge and cloud computing can allow organizations to benefit from both localized processing and the scalability of centralized resources.

The systems and methods described herein may also be distributed in one or more computer program products, each including a computer-readable medium that bears computer-usable instructions for one or more processors. These instructions can exist in various forms, including compiled and non-compiled code, providing the flexibility needed for deployment in diverse computing environments. For example, compiled binaries may be optimized for specific hardware, while interpreted scripts or markup files can be deployed in environments where cross-platform compatibility or rapid updates are needed.

The storage and retrieval of data in a computer system may involve various data storage solutions, including relational databases, which store data in structured tables with defined relationships, and NoSQL databases, which offer more flexible storage schemas suited to unstructured or semi-structured data. In-memory databases, which store data entirely in RAM for rapid access, can also be used in applications where low latency is desirable. These data storage solutions may be implemented on local servers, within distributed storage systems, or as part of cloud-based infrastructures, offering scalability and accessibility as required by the application. Distributed storage solutions can enable high availability and fault tolerance, ensuring that data remains accessible even if one part of the storage infrastructure fails.

Input and output devices connected to the processing device can facilitate interaction with users and other systems. Input devices can include standard peripherals, such as keyboards, mice, touchscreens, and microphones, as well as specialized input devices, such as biometric scanners, cameras, and sensors for capturing environmental data. Output devices may encompass monitors, printers, speakers, projectors, and other display systems that present information to users in various formats. These input and output devices enable users to interact with the system in intuitive ways, supporting diverse functionalities from user control of applications to data visualization and multimedia output.

The systems and methods described herein are thus capable of deployment across a broad spectrum of computing environments, supporting applications from simple embedded systems to large-scale distributed computing networks. Each component and approach described herein contributes to the versatility and adaptability of the present disclosure, making it suitable for a wide variety of practical implementations across industries and use cases.

The disclosed neural network implementations may be realized through various configurations of computer hardware, software, or a combination of both, depending on the requirements and constraints of the particular application. For instance, the neural networks may leverage specialized hardware, such as GPUs, tensor processing units (TPUs), FPGAs, and ASICs, which are designed to efficiently handle the high computational demands of training and deploying neural networks. These hardware components are particularly advantageous for accelerating matrix operations, which are central to neural network computations, and can significantly reduce the time needed for training large models and performing inference tasks.

Alternatively, neural networks can be implemented using traditional computer hardware, including CPUs, which are versatile and widely available. While CPUs are not optimized specifically for neural network computations, they can still handle smaller models and less computationally intensive tasks effectively. In cases where flexibility is essential, such as in general-purpose computing environments, implementing neural networks on CPUs allows for integration with other software systems without the need for specialized hardware.

On the software side, neural networks can be created using various programming languages and frameworks. High-level languages such as Python, Java, and C++ are commonly used for neural network development, particularly in conjunction with deep learning libraries and frameworks like TensorFlow, PyTorch, Keras, and Theano. These frameworks provide prebuilt functions, modules, and tools that simplify the process of designing, training, and deploying neural networks. They allow developers to define network architectures, optimize training parameters, and manage data flows with relative ease. For instance, TensorFlow and PyTorch offer extensive support for GPU and TPU integration, enabling seamless transitions between hardware and software environments.

Neural networks implemented in software may also vary based on the type of language and runtime environment used. For example, imperative languages such as Python and Java allow developers to create neural networks using clear, step-by-step procedural code, making the design process intuitive and manageable. Alternatively, functional languages like Lisp and Haskell may also be employed to build neural networks, particularly when focusing on functional aspects of data flow and transformation. Moreover, neural networks can be implemented in either compiled or interpreted languages, where compiled languages, such as C++ or Java, can offer improved execution speed, while interpreted languages like Python provide flexibility and ease of development.

In certain configurations, neural networks may be deployed in distributed computing environments, allowing for parallel processing across multiple processing units or even across different geographic locations. Distributed implementations can be achieved through cloud computing platforms or high-performance computing (HPC) systems, where workloads are split among numerous machines to improve efficiency and scalability. This is particularly useful for training large-scale models that require significant processing power and storage capacity. Distributed computing frameworks such as Apache Spark and Horovod can facilitate the parallelization of neural network computations, enabling large datasets and complex models to be processed in a fraction of the time that would be required on a single machine.

Neural network implementations may also employ hybrid configurations that combine both hardware and software elements. For example, the core neural network computations might be performed on dedicated hardware accelerators like GPUs or TPUs, while the overall system, including data preprocessing and post-processing steps, can be managed by general-purpose software running on CPUs. This hybrid approach optimizes performance by leveraging the strengths of both hardware and software environments, ensuring efficient resource utilization across different components of the system.

Furthermore, it is understood that the neural networks described herein are not limited to any specific type of architecture. Various neural network architectures, including but not limited to convolutional neural networks (CNNs), recurrent neural networks (RNNs), long short-term memory (LSTM) networks, transformers, and generative adversarial networks (GANs), may be implemented depending on the task requirements. These architectures can be tailored to perform tasks such as image recognition, natural language processing, and predictive modelling, each benefiting from different configurations of hardware and software resources to optimize performance.

For secure and reliable deployment, neural networks may also incorporate mechanisms for data integrity, confidentiality, and robustness against adversarial attacks. Security protocols, such as data encryption and access control, may be applied to safeguard sensitive data processed by the neural network. Techniques like differential privacy and secure multiparty computation can be employed to protect data confidentiality during training and inference. Additionally, the implementation may include error-handling mechanisms and redundancy measures to ensure robust operation, even in environments where hardware failures or software bugs may occur.

Overall, the neural networks in this disclosure may be implemented as flexible, scalable systems that leverage combinations of hardware and software elements tailored to the needs of specific applications. This approach provides versatility, allowing the neural networks to be deployed in a wide range of environments, from dedicated hardware systems to virtualized cloud platforms, thereby supporting a diverse set of use cases and performance requirements.

Any reference to prior art publications within this disclosure should not be taken as an acknowledgment or admission that these publications form part of the common general knowledge in the relevant field, whether in any particular jurisdiction or globally.

The examples provided in the above description serve to illustrate specific embodiments and convey certain features and principles. However, those skilled in the art will recognize that individual features, elements, and functionalities within the disclosed embodiments may be adapted, modified, or combined in numerous ways without departing from the core spirit or intended scope of the described subject matter. Therefore, the foregoing description is meant to be illustrative rather than limiting, with the scope being defined by the appended claims, which are intended to encompass all variations and modifications within the broadest interpretation permitted by applicable law.

1. A method for processing touch sensor data, the method comprising:
obtaining a touch image from the touch sensor, the touch image comprising a plurality of active pixels, each of the active pixels indicating a sensor response;
extracting one or more touch blobs from the touch image and corresponding one or more region-of-interests by a region-of-interest predictor;
obtaining one or more blob images, each associated with one respective touch blob of the touch blobs;
generating, for each respective blob image of the blob images, at least one respective query, respective keys and respective values by encoding the respective blob image using a feature extractor;
for each respective blob image of the blob images, predicting whether the associated respective touch blob corresponds to an intentional finger touch or to a palm touch based on spatial context, the prediction comprising:
generating a context vector for the respective blob image based on cross-attention between the respective blob image and the plurality of blob images,
generating a predicted probability that the blob image corresponds to an intentional finger touch and a predicted probability that the blob image corresponds to a palm touch by inputting the context vector in a classifier, and
predicting that the respective blob image corresponds to an intentional finger touch if the predicted probability that the blob image corresponds to an intentional finger touch is greater than the predicted probability that the blob image corresponds to a palm touch; and
combining a subset of the touch blobs predicted to correspond to a palm touch, the combination comprising, for each respective touch blob of the touch blobs:
extracting spatiotemporal features from the respective touch blob, the spatiotemporal features comprising at least a location and an age of the respective touch blob, and
for each respective pair of touch blobs of the touch blobs, predicting whether the pair of touch blobs correspond to a single palm.

2. The method of claim 1, wherein extracting the one or more touch blobs from the touch image is based on a first threshold and a second threshold and comprises:
generating a graph comprising a set of vertices and a set of edges, each of the vertices being associated with an active pixel and being decorated with the sensor response of the active pixel, and each of the edges being associated with a pair of adjacent pixels of the active pixels and connecting a pair of vertices associated with the pair of adjacent pixels;
traversing the graph to identify one or more subgraphs connected through connecting vertices each decorated with a sensor response above the first threshold;
continuing traversing the graph to expend the subgraphs until a cutoff condition related to a current vertex and a previous vertex is met, the cutoff conditions comprising:
the current vertex being decorated with a sensor response greater than the sensor response decorating the previous vertex,
the current vertex being already part of one of the components, and
the current vertex being decorated with a sensor response less than the second threshold, wherein the second threshold is less than the first threshold; and
generating the one or more touch blobs, each corresponding to one of the subgraphs.

3. The method of claim 1, wherein the feature extractor is a neural encoder.

4. The method of claim 3, wherein the feature extraction neural encoder comprises a plurality of convolutional layers and at least one dense layer.

5. The method of claim 3, further comprising storing past blob images from the touch sensor, wherein the prediction is further based on temporal context and wherein the feature extraction neural encoder further comprising at least one hidden layer.

6. The method of claim 1, further comprising
generating a feature embedding corresponding to the spatiotemporal features by a blob combination neural encoder.

7. The method of claim 1, further comprising identifying hovers by performing temporal smoothing of the touch image based on the past touch images.

8. The method of claim 7, wherein the temporal smoothing is based on exponential smoothing.

9. The method of claim 1, further comprising:
computing at least one gradient from:
a gradient a variation over time of the indicated sensor response for each of the touch blobs, and
at least one gradient of a variation over at least one spatial dimension of the indicated sensor values for each of the touch blobs; and
providing the at least one gradient as additional input to the classifier.

10. The method of claim 1, further comprising, for each respective touch blob of the touch blobs in past blob images predicted to correspond to a palm touch:
extracting spatial features from the respective touch blob, the spatial features comprising at least a location and a shape; and
estimating a hand model to predict the probability that an input blob image corresponds to an intentional or a palm touch,
wherein predicting whether the respective touch image corresponds to an intentional or a palm touch is further based on a prediction of the hand model.

11. The method of claim 10, wherein predicting whether the respective touch image corresponds to an intentional or a palm touch is based on a weighted sum of the predicted probabilities of the classifier and the predicted probabilities of the hand model, and wherein the weight is determined based on a number of touches used to estimate the hand model.

12. An apparatus comprising:
one or more processors; and
a memory storing instructions which, when executed by the one or more processors, cause the apparatus to:
obtain a touch image from the touch sensor, the touch image comprising a plurality of active pixels, each of the active pixels indicating a sensor response;
extract one or more touch blobs from the touch image and corresponding one or more region-of-interests by a region-of-interest predictor;
obtain one or more blob images, each associated with one respective touch blob of the touch blobs;
generate, for each respective blob image of the blob images, at least one respective query, respective keys and respective values by encoding the respective blob image using a feature extractor;
for each respective blob image of the blob images, predict whether the associated respective touch blob corresponds to an intentional finger touch or to a palm touch based on spatial context, the predicting comprising:
generating a context vector for the respective blob image based on cross-attention between the respective blob image and the plurality of blob images,
generating a predicted probability that the blob image corresponds to an intentional finger touch and a predicted probability that the blob image corresponds to a palm touch by inputting the context vector in a classifier, and
predicting that the respective blob image corresponds to an intentional finger touch if the predicted probability that the blob image corresponds to an intentional finger touch is greater than the predicted probability that the blob image corresponds to a palm touch; and
combining a subset of the touch blobs predicted to correspond to a palm touch, the combination comprising, for each respective touch blob of the touch blobs:
extracting spatiotemporal features from the respective touch blob, the spatiotemporal features comprising at least a location and an age of the respective touch blob, and
for each respective pair of touch blobs of the touch blobs, predicting whether the pair of touch blobs correspond to a single palm.

13. The apparatus of claim 12, wherein extracting the one or more touch blobs from the touch image is based on a first threshold and a second threshold and comprises:
generating a graph comprising a set of vertices and a set of edges, each of the vertices being associated with an active pixel and being decorated with the sensor response of the active pixel, and each of the edges being associated with a pair of adjacent pixels of the active pixels and connecting a pair of vertices associated with the pair of adjacent pixels;
traversing the graph to identify one or more subgraphs connected through connecting vertices each decorated with a sensor response above the first threshold;
continuing traversing the graph to expend the subgraphs until a cutoff condition related to a current vertex and a previous vertex is met, the cutoff conditions comprising:
the current vertex being decorated with a sensor response greater than the sensor response decorating the previous vertex,
the current vertex being already part of one of the components, and
the current vertex being decorated with a sensor response less than the second threshold, wherein the second threshold is less than the first threshold; and
generating the one or more touch blobs, each corresponding to one of the subgraphs.

14. The apparatus of claim 12, wherein the feature extractor is a neural encoder.

15. The apparatus of claim 14, wherein the feature extraction neural encoder comprises a plurality of convolutional layers and at least one dense layer.

16. The apparatus of claim 14, further comprising storing past blob images from the touch sensor, wherein the prediction is further based on temporal context and wherein the feature extraction neural encoder further comprising at least one hidden layer.

17. The apparatus of claim 12, further comprising
generating a feature embedding corresponding to the spatiotemporal features by a blob combination neural encoder.

18. The apparatus of claim 12, further comprising identifying hovers by performing temporal smoothing of the touch image based on the past touch images.

19. The apparatus of claim 18, wherein the temporal smoothing is based on exponential smoothing.

20. A non-transitory, computer-readable medium storing instructions that, when executed by a processor, configure the processor to:
obtain a touch image from the touch sensor, the touch image comprising a plurality of active pixels, each of the active pixels indicating a sensor response;
extract one or more touch blobs from the touch image based on a first threshold and a second threshold and corresponding one or more region-of-interests by a region-of-interest predictor, extracting the one or more touch blobs from the touch image comprising:
generating a graph comprising a set of vertices and a set of edges, each of the vertices being associated with an active pixel and being decorated with the sensor response of the active pixel, and each of the edges being associated with a pair of adjacent pixels of the active pixels and connecting a pair of vertices associated with the pair of adjacent pixels,
traversing the graph to identify one or more subgraphs connected through connecting vertices each decorated with a sensor response above the first threshold,
continuing traversing the graph to expend the subgraphs until a cutoff condition related to a current vertex and a previous vertex is met, and
generating the one or more touch blobs, each corresponding to one of the subgraphs;
obtain one or more blob images, each associated with one respective touch blob of the touch blobs;
generate, for each respective blob image of the blob images, at least one respective query, respective keys and respective values by encoding the respective blob image using a feature extractor; and
for each respective blob image of the blob images, predict whether the associated respective touch blob corresponds to an intentional finger touch or to a palm touch based on spatial context, the predicting comprising:
generating a context vector for the respective blob image based on cross-attention between the respective blob image and the plurality of blob images,
generating a predicted probability that the blob image corresponds to an intentional finger touch and a predicted probability that the blob image corresponds to a palm touch by inputting the context vector in a classifier, and
predicting that the respective blob image corresponds to an intentional finger touch if the predicted probability that the blob image corresponds to an intentional finger touch is greater than the predicted probability that the blob image corresponds to a palm touch.
